(19) United States
(12) Patent Application Publication
(10) Pub. No.: US 2006/0032990 A1
(43) Pub. Date: Feb. 16, 2006

(54) Rack and duct system

(76) Inventor: John Alexander Cask, Hurstville (AU)

Correspondence Address: LADAS & PARRY, 26 WEST 61ST STREET, NEW YORK, NY, 10023, US

(21) Appl. No.: 11/055,577

(22) Filed: Feb. 10, 2005

(30) Foreign Application Priority Data
Aug. 11, 2004 (AU) 2004203819

(51) Int. Cl. F16L 5/00

(52) U.S. Cl. 248/56

(57) ABSTRACT

A system for routing electronic data cables issuing from an array of data processing device cabinets arranged side by side; said system comprising a plurality of vertically spaced-apart, substantially horizontal ducts, arranged along said array of data processing device cabinets.

The present invention relates to racks for electronic devices and, more particularly to racks incorporating ducting for a distributed cabling array.

### BACKGROUND

In many medium and large organizations, the number of computers employed and their networking, both within a local geographic location and with remote associated locations, may demand a large number of server and router modules to facilitate their interaction. At least for some medium and smaller operations it may be preferable to assign the installation and maintenance of such equipment to a specialist data processing management facility.

In some such situations, the number of servers and routers to be managed can become very large with a concomitant large number of data cables from the modules to cable consolidation points and switching and patching stations. Particularly where such installations are in a service organization where the server and router modules are owned or leased by customers, the not infrequent need to remove and replace modules and route their associated cabling becomes a complex and time consuming task. As well, it is difficult to maintain security of the equipment where the interconnecting cable bundles are readily accessible by other than authorized personnel.

It is an object of the present invention to address or at least ameliorate some of the above disadvantages.

### BRIEF DESCRIPTION OF INVENTION

Accordingly, in a first broad form of the invention there is provided a system for routing electronic data cables issuing from an array of data processing device cabinets arranged side by side; said system comprising a plurality of vertically spaced-apart, substantially horizontal ducts, arranged along said array of data processing device cabinets.

Preferably, said ducts are supported between a pair of upright support elements to form a duct module.

Preferably, said ducts comprise inverted channel sections; said channel sections provided with cover elements extending along said inverted channel section between said support elements.

Preferably, said cover elements are hinged from one vertical flange of said inverted channel section.

Preferably, each of said cover elements is provided with at least one key operated locking device arranged to prevent rotation of said cover element from a closed position to an open position when said locking device is in a locked condition.

Preferably, said support elements comprise a pair of upright channel sections arranged at opposing outer ends of said ducts such that respective said outer ends of each of said ducts are nested in said upright channel sections.

Preferably, said ducts are releasably retained in said upright channel sections by means of retainer fasteners inserted through cooperating slots and holes provided in said outer ends and in flanges of said upright channel sections respectively.

Preferably, each said duct module is arranged to correspond in length with a predetermined number of data processing device cabinets in said array.

Preferably, outer ones of said cabinets in said array are releasably attached to said upright channel sections.

Preferably, each said duct module is configured in one of at least two application modes.

Preferably, in a first one of said application modes, said duct module is adapted for four standard 600 mm device cabinets arranged side by side.

Preferably, in a second one of said application modes, said duct module is adapted for one 800 mm standard cable consolidation device cabinet and two flanking standard 600 mm device cabinets.

Preferably, at each position along said length of said duct module, coinciding with said device cabinets, said ducts are provided with at least one cable access hole in a flange of said channel sections adjacent said device cabinets.

Preferably, flanges of said ducts facing said cabinets are provided with cut-out portions at said cable consolidation device cabinet; said cut-out portions adapted to allow placement of multiple cables into said ducts for connection to cable consolidation devices.

Preferably, said duct modules are adapted for end to end association so as to form a line of multiple said duct modules.

Preferably, said upright channel sections are provided with apertures in base webs of said channel sections; said apertures adapted for passage of said cabling from one module to an adjoining module.

Preferably, each line of said modules includes at least one module of said second one of said application modes.

In a further broad form of the invention there is provided a duct module comprising a plurality of vertically spaced-apart, substantially horizontal ducts, arranged between upright support members; said duct module adapted for routing of data processing cables issuing from an array of data processing device cabinets arranged side by side.

Preferably, said ducts comprise inverted channel sections; said channel sections provided with cover elements extending along said inverted channel section between said support elements.

Preferably, said cover elements are hinged from one vertical flange of said inverted channel section.

Preferably, each of said cover elements is provided with at least one key operated locking device arranged to prevent rotation of said cover element from a closed position to an open position when said locking device is in a locked condition.

Preferably, said support members comprise a pair of upright channel sections arranged at opposing outer ends of said ducts such that respective said outer ends of each of said ducts are nested in said upright channel sections.

Preferably, said ducts are releasably retained in said upright channel sections by means of retainer fasteners inserted through cooperating slots and holes provided in said outer ends and in flanges of said upright channel sections respectively.

Preferably, each said duct module is arranged in length to correspond with a predetermined number of said array of data processing device cabinets.

Preferably, outer ones of said cabinets in said array are releasably attached to said upright channel sections.

Preferably, each said duct module is configured in one of at least two application modes.

Preferably, in a first one of said two application modes, said duct modules are adapted for four standard 600 mm device cabinets arranged side by side.

Preferably, in a second one of said application modes, said module is adapted for one 800 mm standard cable consolidation device cabinet and two flanking standard 600 mm device cabinets.

Preferably, at each position along said length of said duct module, coinciding with said device cabinets, said ducts are provided with at least one cable access hole in a flange of said channel sections adjacent said device cabinets.

Preferably, flanges of said ducts facing said cabinets are provided with cut-out portions at said cable consolidation device cabinet; said cut-out portions adapted to allow placement of multiple cables into said ducts for connection to cable consolidation devices.

Preferably, said duct modules are adapted for end to end association so as to form a line of multiple said duct modules.

Preferably, said upright channel sections are provided with apertures in base webs of said channel sections; said apertures adapted for passage of said cabling from one module to an adjoining module.

Preferably, each line of said modules includes at least one module of said second one of said application modes.

### BRIEF DESCRIPTION OF DRAWINGS

Embodiments of the present invention will now be described with reference to the accompanying drawings wherein:

FIG. 1 is a rear elevation view of a preferred embodiment of a rack and duct system according to the invention.

FIG. 2 is a plan view of the rack and duct system of FIG. 1.

FIG. 3 is a perspective view of a portion of one end of a module of the rack and duct system of FIG. 1.

FIG. 4 is a close up perspective view of a portion of the end of the module of FIG. 3.

FIG. 5 is a front elevation view of a first configuration of the module of FIG. 3, and

FIG. 6 is a front view of a second configuration of the module of FIG. 3.

### DETAILED DESCRIPTION OF PREFERRED EMBODIMENTS

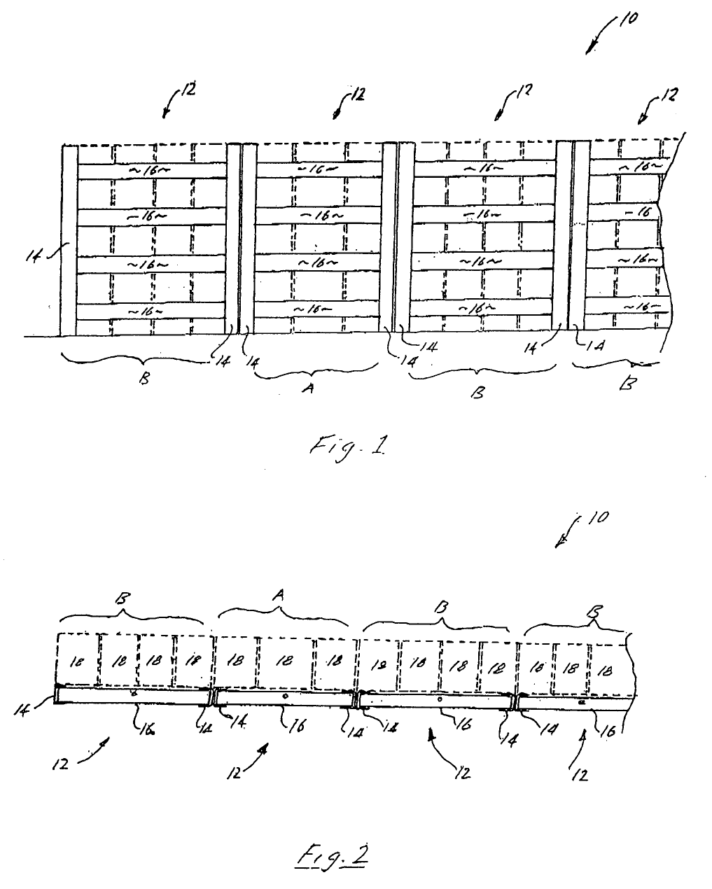

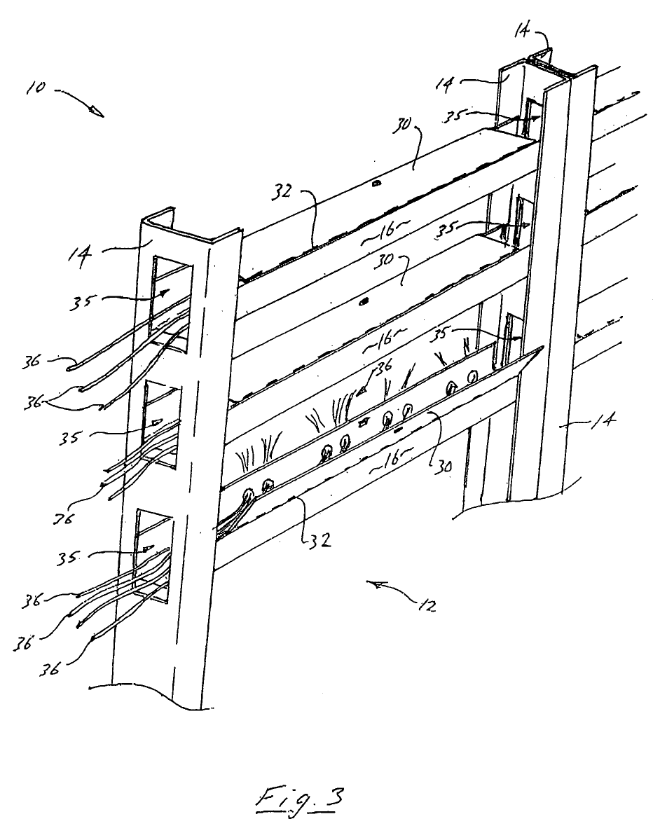

With reference to FIGS. 1 to 3, a modular rack and duct system 10 comprises one or more modular units 12. Each modular unit 12 is formed of a pair of upright support elements 14 and a plurality of horizontal cable ducts 16. Rack and duct system 10 is arranged to flank the rear of a number of electronic data processing device cabinets 18 (shown in dashed outline) arranged side by side.

Upright support elements 14 may consist of open channel sections, for example of galvanized iron or aluminium. Cable ducts 16 likewise may consist of lengths of similar but slightly narrower open channel section such that, with the open side of the channel section facing upwards, the outer ends of the cable ducts 16 may nest within the open channel section of the uprights 14.

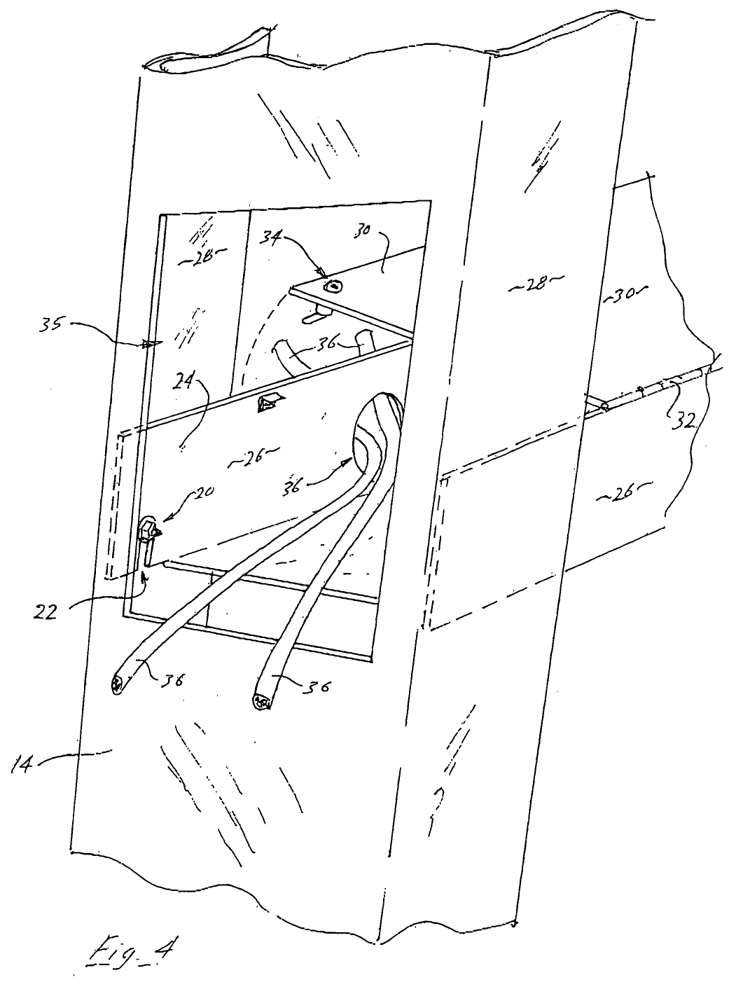

As shown in FIG. 4, ends of the channel section of each of the cable ducts 16 is releasably retained within the uprights 14 by means of suitable fasteners 20 passing through slots 22 in extensions 24 of side flanges 26, and holes in side flanges 28 of uprights 14. Uprights 14 are attached to the structural uprights of the cabinets 18 by suitable fastening means (not shown).

As best seen in FIGS. 3 and 4 each duct 16 is provided with a cover element 30 hinged by hinge 32 from one of the flanges 26 of duct 16 and sized so as to close off that portion of the open channel section of the duct lying between the opposing uprights 14. Each cover element is provided with at least one key operated locking device 34 so as to secure cover element 33 in a closed position.

Again with reference to FIGS. 3 and 4, the base web of each of the upright member 14 is provided with apertures 35 aligned with ducts 16 to allow cabling 36 to pass from one modular unit to an adjoining modular unit.

Modular units 12 are configured in one of two arrangements. The first of these, (type “A” in FIG. 1) is adapted in length to extend along the rear of a predetermined number, for example four, standard 600 mm cabinets 18 for the racking of electronic data processing devices such as computer servers and routers (not shown). The second of these, (type “B” in FIG. 1) may also provide for a number of standard 600 mm cabinets, for example two, flanking a standard 800 mm cabinet serving as a cable consolidation point for the devices in the other 600 mm cabinets. Thus a cable and duct system of the present invention will comprise as a minimum a type “A” modular unit but may be expanded to form a line of additional “B” type modular units extending from one or from both ends of the “A” modular unit.

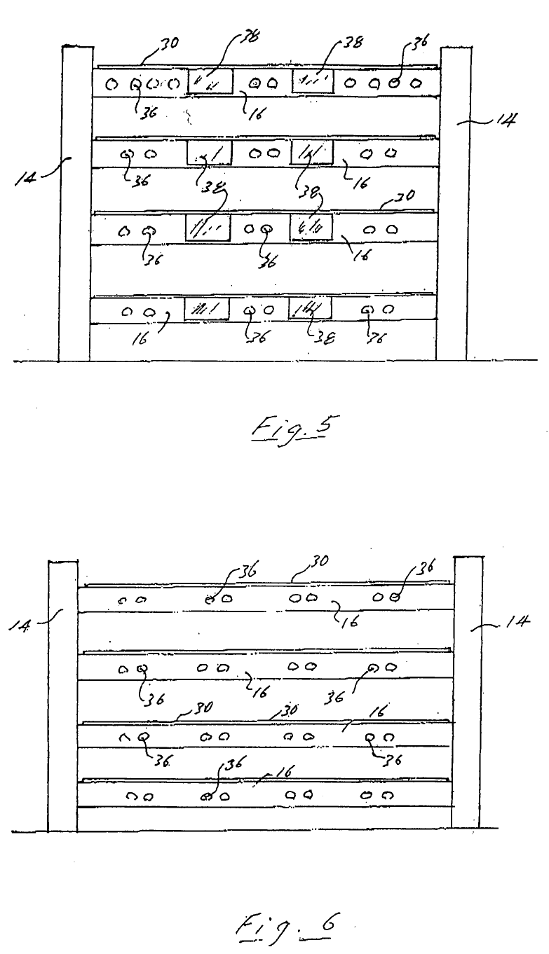

As shown in FIGS. 4, 5 and 6, both “A” and “B” type modules are provided with a number of cable holes 36 arranged in the flange 26 of each of the ducts 16 facing the rear of the cabinets 18, that is in the front flanges of the ducts. Each duct is provided with at least one such cable hole corresponding to the location adjacent the duct of a cabinet 18. Additionally, “A” type modules may be provided with cut-out portions 38 at the location of the 800 mm cabinet, extending from the top edge of the flange so as to allow the large number of cables collecting at these locations to be readily positioned in the duct.

For use, the system may be prepared with cabling to service all of the possible device locations of the cabinets 18 in the line of modular units 12, each of the cables suitably labeled at each end for identification. Any device may then be installed or replaced and rapidly connected, saving considerable time and effort and with the cabling neatly accommodated within the ducts. Because the ducts may be locked, interference with the cabling by unauthorized persons is prevented.

In a further embodiment of the invention, the spaces between each of the ducts coinciding with the rear of a 5 cabinet may be provided with a security panel (not shown). Such a panel could be formed of transparent acrylic sheet for example, and may be hinged from the channel section of the duct above or below the space, and provided with a key operated locking device.

The above describes only some embodiments of the present invention and modifications, obvious to those skilled in the art, can be made thereto without departing from the scope and spirit of the present invention.

1. A system for routing electronic data cables issuing from an array of data processing device cabinets arranged side by side; said system comprising a plurality of vertically spaced-apart, substantially horizontal ducts, arranged along said array of data processing device cabinets.

2. The system of claim 1, wherein said ducts are supported between a pair of upright support elements to form a duct module.

3. The system of claim 2, wherein said ducts comprise inverted channel sections; said channel sections provided with cover elements extending along said inverted channel section between said support elements.

4. The system of claim 3, wherein said cover elements are hinged from one vertical flange of said inverted channel section.

5. The system of claim 3, wherein each of said cover elements is provided with at least one key operated locking device arranged to prevent rotation of said cover element from a closed position to an open position when said locking device is in a locked condition.

6. The system of claim 2, wherein said support elements comprise a pair of upright channel sections arranged at opposing outer ends of said ducts such that respective said outer ends of each of said ducts are nested in said upright channel sections.

7. The system of claim 6, wherein said ducts are releasably retained in said upright channel sections by means of retainer fasteners inserted through cooperating slots and holes provided in said outer ends and in flanges of said upright channel sections respectively.

8. The system of claim 2, wherein each said duct module is arranged to correspond in length with a predetermined number of data processing device cabinets in said array.

9. The system of claim 6, wherein outer ones of said cabinets in said array are releasably attached to said upright channel sections.

10. The system of claim 6, wherein each said duct module is configured in one of at least two application modes.

11. The system of claim 10, wherein, in a first one of said application modes, said duct module is adapted for four standard 600mm device cabinets arranged side by side.

12. The system of claim 10, wherein in a second one of said application modes, said duct module is adapted for one 800 mm standard cable consolidation device cabinet and two flanking standard 600 mm device cabinets.

13. The system of claim 6, wherein at each position along said length of said duct module, coinciding with said device cabinets, said ducts are provided with at least one cable access hole in a flange of said channel sections adjacent said device cabinets.

14. The system of claim 12, wherein flanges of said ducts facing said cabinets are provided with cut-out portions at said cable consolidation device cabinet; said cut-out portions adapted to allow placement of multiple cables into said ducts for connection to cable consolidation devices.

15. The system claim 2, wherein said duct modules are adapted for end to end association so as to form a line of multiple said duct modules.

16. The system of claim 6, wherein said upright channel sections are provided with apertures in base webs of said channel sections; said apertures adapted for passage of said cabling from one module to an adjoining module.

17. The system of claim 12, wherein each line of said modules includes at least one module of said second one of said application modes.

18. A duct module comprising a plurality of vertically spaced-apart, substantially horizontal ducts, arranged between upright support members; said duct module adapted for routing of data processing cables issuing from an array of data processing device cabinets arranged side by side.

19. The duct module of claim 18, wherein said ducts comprise inverted channel sections; said channel sections provided with cover elements extending along said inverted channel section between said support elements.

20. The duct module of claim 19, wherein said cover elements are hinged from one vertical flange of said inverted channel section.

21. The duct module of claim 19, wherein each of said cover elements is provided with at least one key operated locking device arranged to prevent rotation of said cover element from a closed position to an open position when said locking device is in a locked condition.

22. The duct module of claim 18, wherein said support members comprise a pair of upright channel sections arranged at opposing outer ends of said ducts such that respective said outer ends of each of said ducts are nested in said upright channel sections.

23. The duct module of claim 22, wherein said ducts are releasably retained in said upright channel sections by means of retainer fasteners inserted through cooperating slots and holes provided in said outer ends and in flanges of said upright channel sections respectively.

24. The duct module of claim 18, wherein each said duct module is arranged in length to correspond with a predetermined number of said array of data processing device cabinets.

25. The duct module of claim 22, wherein outer ones of said cabinets in said array are releasably attached to said upright channel sections.

26. The duct module of claim 18, wherein each said duct module is configured in one of at least two application modes.

27. The duct module of claim 26, wherein in a first one of said two application modes, said duct modules are adapted for four standard 600 mm device cabinets arranged side by side.

28. The duct module of claim 26, wherein in a second one of said application modes, said module is adapted for one 800 mm standard cable consolidation device cabinet and two flanking standard 600 mm device cabinets.

29. The duct module of claim 24, wherein at each position along said length of said duct module, coinciding with said device cabinets, said ducts are provided with at least one cable access hole in a flange of said channel sections adjacent said device cabinets.

30. The duct module of claim 28, wherein flanges of said ducts facing said cabinets are provided with cut-out portions at said cable consolidation device cabinet; said cut-out portions adapted to allow placement of multiple cables into said ducts for connection to cable consolidation devices.

31. The duct module of claim 18, wherein said duct modules are adapted for end to end association so as to form a line of multiple said duct modules.

32. The duct module of claim 22, wherein said upright channel sections are provided with apertures in base webs of said channel sections; said apertures adapted for passage of said cabling from one module to an adjoining module.

33. The duct module of claim 26, wherein each line of said modules includes at least one module of said second one of said application modes.

34. (canceled)
